(19) United States
(12) Patent Application Publication
(10) Pub. No.: US 2021/0128395 A1
(43) Pub. Date: May 6, 2021

(54) Stimulation Device

(71) Applicant: EIS GmbH, Bielefeld (DE)

(72) Inventor: Florian Witt, Wentorf (DE)

(73) Assignee: EIS GmbH, Bielefeld (DE)

(21) Appl. No.: 16/618,346

(22) PCT Filed: May 31, 2018
(86) PCT No.: PCT/EP2018/064352

§ 371 Date: Nov. 30, 2019

(30) Foreign Application Priority Data
May 31, 2017 (DE) 10 2017 005 213.1
Jun. 7, 2017 (DE) 10 2017 112 561.2

(51) Int. Cl. A61H 7/00

(52) U.S. Cl. CPC A61H 7/004; A61H 19/32

(57) ABSTRACT

A stimulation device including a sleeve-shaped body formed by an at least partially flexible wall which has a first end portion with a first end forming a first end of the sleeve-shaped body and a second end portion forming a second end of the sleeve-shaped body and containing an opening through which a body part sensitive to stimulation is inserted into the sleeve-shaped body. A loading mechanism is configured to subject the first end portion of the wall of the sleeve-shaped body to a force which changes the distance between the first end and second end of the sleeve-shaped body; in particular a time-variant first force that oscillates as a tensile force for relative lengthening of the distance between the first end and second end of the sleeve-shaped body and a pressure force for relative shortening of the distance between the first end and second end of the sleeve-shaped body.

The invention relates to a stimulation appliance having a sleeve-like body formed by an at least partially flexible wall that has a first end portion with a first end forming a first end of the sleeve-like body, and a second end portion, remote from the first end portion, with a second end forming a second end of the sleeve-like body, said second end being located substantially opposite the first end, being arranged at a distance from the first end, and containing an opening for introducing a body part that is sensitive to stimulation into the sleeve-like body.

Such a stimulation appliance is known and is used in particular for stimulating a penis, which, for this purpose, is intended to be introduced into the sleeve-like body through the opening. Preferably, the sleeve-like body is an insert made of soft-elastic material, which is brought into touching engagement or into rubbing engagement with the body part that is sensitive to stimulation.

It is an object of the present invention to propose a stimulation appliance of the type mentioned at the beginning that has a better stimulation-inducing effect.

This object is achieved by a stimulation appliance having a sleeve-like body formed by an at least partially flexible wall that has a first end portion with a first end forming a first end of the sleeve-like body, and a second end portion, remote from the first end portion, with a second end forming a second end of the sleeve-like body, said second end being located substantially opposite the first end, being arranged at a distance from the first end, and containing an opening for introducing a body part that is sensitive to stimulation into the sleeve-like body, characterized by an application device, which is configured to apply a temporally variable, in particular oscillating first force that varies the distance between the first end of the sleeve-like body and the second end of the sleeve-like body to the first end portion of the wall of the sleeve-like body, alternately as a tensile force for a relative increase in the distance between the first end and the second end of the sleeve-like body and as a compressive force for a relative decrease in the distance between the first end and the second end of the sleeve-like body.

With the aid of the application device provided according to the invention, not only a better but also a different kind of stimulating effect can be achieved compared with the prior art. This is achieved according to the invention in that the sleeve-like body is alternately lengthened and shortened in the direction of its length with the first end portion of its wall, which is the internal end portion, and thus with its internal first end. The resultant alternate change in length of the internal first end portion of the wall of the sleeve-like body generates a particular stimulating action on the portion of the body part that is sensitive to stimulation, has been introduced into the sleeve-like body through the opening and is in engagement with the first end portion of the wall of the sleeve-like body, either in that, on account of a relative movement of the first end portion of the wall of the sleeve-like body with respect to the adjacent portion of the body part, a stimulating rubbing action is generated on the latter, or in that the first end portion of the wall of the sleeve-like body, while moving alternately in its two directions, carries along the adjacent portion of the body part or at least the skin thereof, this likewise resulting in a particular stimulating effect.

Preferred embodiments and developments of the invention are specified in the dependent claims.

In particular for the stimulation of elongate body parts, for example a penis, it is expedient for the sleeve-like body to have an elongate shape between its first end and its second end and for the application device to be configured to orient the first force approximately in the longitudinal direction of the sleeve-like body.

A preferred embodiment is distinguished by the fact that, outside the sleeve-like body, a chamber is provided, the wall of which has a first portion that is formed at least partially by the first end portion of the wall of the sleeve-like body, and the application device is configured, in order to apply the first force as a tensile force to the first end portion of the wall of the sleeve-like body, to generate a negative pressure in the chamber in order to increase the distance between the first end and the second end of the sleeve-like body, and, in order to apply the first force as a compressive force to the first end portion of the wall of the sleeve-like body, to generate a positive pressure in the chamber. In this embodiment, the application device acts so to speak pneumatically and can thus be realized in a particularly simple and at the same time effective manner.

In a development of this embodiment, the wall of the chamber has an at least partially flexible second portion, and the application device has a drive device, which is configured to move the second portion of the wall of the chamber in a reciprocating manner between a first position and a second position, in order then to alternately generate a negative pressure and a positive pressure.

In one development, the second portion of the wall of the chamber is located opposite the first portion thereof and is arranged at a distance from the first portion thereof.

Furthermore, the drive device may be configured to move the second portion of the wall of the chamber approximately in the longitudinal direction of the sleeve-like body. As a result, the positive and negative pressure effecting the change in length of the sleeve-like body can be generated in a simple and particularly effective manner. Expediently, the second portion of the wall of the chamber has a diaphragm, the reciprocating movement of which, brought about by the drive device of the application device, alternately ensures the generation of a positive pressure and of a negative pressure.

Preferably, the appliance is provided with a housing that has a wall and receives the sleeve-like body and the application device, wherein the second end portion of the wall of the sleeve-like body is fastened to the wall of the housing.

Preferably, the chamber has a closable opening that leads into the environment. A user can expediently use their finger to partially or completely close this opening if required, in order in this way to manually control the pressure in the chamber. If the opening is completely closed, the pressure conditions in the first chamber remain unchanged. If, by contrast, the opening is partially closed or open, this brings about slight pressure equalization with the environment, with the result that the pressure in the first chamber is accordingly lower. In this case, the opening may contain a nonreturn valve, which closes when there is a negative pressure in the chamber and opens when there is a positive pressure in the chamber; in this way, manual control with the aid of the user's finger is possible only when there is positive pressure, while undesired pressure equalization with the environment is avoided when there is negative pressure.

Preferably, the wall of the chamber has a third portion and the wall of the sleeve-like body is fastened to the third portion of the wall of the chamber in the region of or next to the first portion thereof. In this case, the third portion of the wall of the chamber may be arranged between the first portion thereof and the second portion thereof. For advantageous fixing of the sleeve-like body to the housing, an outwardly projecting collar is preferably formed on the outer side of the wall of the sleeve-like body in the region of or next to the first end portion thereof, said collar being fastened to the third portion of the wall of the chamber.

In a further preferred embodiment, the appliance is provided with a housing that receives the sleeve-like body and the application device and has a first housing part and a second housing part arranged in a removable manner on the first housing part, wherein the first housing part receives the sleeve-like body with the second end portion of its wall and is arranged on the second housing part in the region of the first end portion of the wall of the sleeve-like body or next to the first end portion thereof. Such a two-part embodiment of the housing allows easier cleaning of the interior of the housing and of the sleeve-like body and also easy exchange of the sleeve-like body, and also allows easy access to the application device for example for the purpose of repairs or exchanging or replacing a battery that supplies the application device with voltage.

An alternative embodiment, in which the wall of the sleeve-like body has an intermediate portion, provided between the first end portion and the second end portion, with wall portions that are located opposite one another at a distance defining an opening cross section of the sleeve-like body, is distinguished by the fact that the application device is furthermore configured to apply a temporally variable, in particular oscillating second force that varies the distance between the mutually opposite wall portions of the intermediate portion of the wall if the sleeve-like body to the intermediate portion of the wall of the sleeve-like body, alternately as a compressive force for a relative decrease in the distance between the mutually opposite wall portions and as a tensile force for a relative increase in the distance between the mutually opposite wall portions. With this alternative embodiment, the stimulating effect can be enhanced even further in that the application device not only alternately applies a tensile force and a compressive force in the longitudinal direction of the sleeve-like body to the internal first end portion of the wall of the sleeve-like body and thus the internal first end thereof, in order to change the length of the sleeve-like body and thus to periodically stretch the latter, but also alternately applies a tensile force and compressive force acting transversely to its longitudinal direction to the sleeve-like body at a point between its first end and its second end, in order to change the cross section of the sleeve-like body and thus to periodically form a constriction in the sleeve-like body.

A development of this embodiment is characterized in that the application device is configured to apply the first force as tensile force to the first end portion of the wall of the sleeve-like body and the second force as compressive force to the intermediate portion of the wall of the sleeve-like body at substantially the same time and/or to apply the first force as compressive force to the first end portion of the wall of the sleeve-like body and the second force as tensile force to the intermediate portion of the wall of the sleeve-like body at substantially the same time. Accordingly, in this development, the application device alternately effects a cross-sectional constriction of the sleeve-like body at the same time as stretching the latter in the longitudinal direction and a widening and in particular return of the sleeve-like body to its starting cross section at the same time as shortening the latter in particular to its starting length.

Preferably, the sleeve-like body has an elongate form between its first end and its second end, in particular for stimulating elongate body parts, for example a penis, and the application device is configured to orient the second force approximately transversely to the longitudinal direction of the sleeve-like body.

Expediently, the ratio between the first force and the second force should be such that the volume of the cavity bounded by the sleeve-like body remains substantially unchanged.

A further preferred development of the alternative embodiment specified above is characterized in that, outside the sleeve-like body, a first chamber is provided, the wall of which has a first portion that is formed at least partially by the first end portion of the wall of the sleeve-like body, outside the sleeve-like body and the first chamber, a second chamber is provided, the wall of which has a first portion that is formed at least partially by the intermediate portion of the wall of the sleeve-like body, and the application device is configured, in order to apply the first force as tensile force to the first end portion of the wall of the sleeve-like body, to generate a negative pressure in the first chamber in order to increase the distance between the first end and the second end of the sleeve-like body, in order to apply the first force as a compressive force to the first end portion of the wall of the sleeve-like body, to generate a positive pressure in the first chamber, in order to apply the second force as compressive force to the intermediate portion of the wall of the sleeve-like body, to generate a positive pressure in the second chamber, and in order to apply the second force as tensile force to the intermediate portion of the wall of the sleeve-like body, to generate a negative pressure in the second chamber. Accordingly, in this development, the positive pressure that arises upon expansion of the sleeve-like body in the longitudinal direction is used cleverly for the constriction of the sleeve-like body, intended substantially at the same time. In this case, the magnitude of the difference between the negative pressure and a normal pressure should expediently correspond approximately to the magnitude of the difference between the positive pressure and the normal pressure.

In a further preferred development, the wall of the first chamber has an at least partially flexible second portion and the wall of the second chamber has a second portion that is formed by the second portion of the wall of the first chamber, and the application device has a drive device that is configured to move the second portion of the wall of the first chamber in a reciprocating manner between a first position and a second position. In this case, the second portion of the wall of the first chamber should preferably be located opposite the first portion thereof and be arranged at a distance from the first portion thereof.

Preferably, the drive device should be configured to move the second portion of the wall of the first chamber approximately in the longitudinal direction of the sleeve-like body. As a result, the positive pressure and negative pressure effecting the change in length of the sleeve-like body can be generated in a simple and particularly effective manner. Expediently, the second portion of the wall of the first chamber has a diaphragm.

In the alternative embodiment, too, the appliance may be provided with a housing that has a wall and receives the sleeve-like body and the application device, wherein the wall of the second chamber has a third portion that is spaced apart from the first portion thereof and is formed by a portion of the wall of the housing.

For particularly effective fixing of the sleeve-like body to the housing, the second end portion of the wall of the sleeve-like body may be fastened to the wall of the housing. In this case, the second end portion of the wall of the sleeve-like body should at the same time form a sealing end of the second chamber against the wall of the housing, in order to prevent undesired pressure equalization with the environment.

In the alternative embodiment, too, the first chamber may preferably have a closable opening that leads into the environment and, for manual control of the pressure conditions in the first chamber, can expediently be partially or completely closed with the user's finger. If the opening is completely closed, the pressure conditions in the first chamber remain unchanged. By contrast, if the opening is partially closed or open, this brings about slight pressure equalization with the environment, with the result that the pressure in the first chamber is accordingly lower. The opening may preferably contain a nonreturn valve, which closes when there is a negative pressure in the first chamber and opens when there is a positive pressure in the first chamber, such that in the event of a negative pressure in the first chamber, undesired pressure equalization with the environment is prevented and manual control of the pressure conditions in the first chamber by using the user's finger to partially or completely close the opening is possible only in the event of a positive pressure in the first chamber.

In a development of the alternative embodiment, the wall of the first chamber has a third portion, and the wall of the sleeve-like body is fastened to the third portion of the wall of the first chamber in the connecting region between the first end portion thereof and the intermediate portion thereof.

In a further preferred development, the third portion of the wall of the first chamber is arranged between the first portion thereof and the second portion thereof.

For further advantageous fixing of the sleeve-like body, an outwardly projecting collar is preferably formed on the outer side of the wall of the sleeve-like body in the connecting region between the first end portion thereof and the intermediate portion thereof, said collar being fastened to the third portion of the wall of the first chamber.

Furthermore, the wall of the second chamber may have a fourth portion that is formed by the third portion of the wall of the first chamber.

In the alternative embodiment, too, the appliance may preferably be provided with a housing that receives the sleeve-like body and the application device and has a first housing part and a second housing part arranged in a removable manner on the first housing part, wherein the first housing part receives the sleeve-like body substantially with the intermediate portion and the second end portion of its wall and is arranged on the second housing part in the connecting region between the first end portion and the intermediate portion of the wall of the sleeve-like body. Such a two-part embodiment of the housing allows easier cleaning of the interior of the housing and of the sleeve-like body and also easy exchange of the sleeve-like body, and also allows easy access to the application device for example for the purpose of repairs or exchanging or replacing a battery that supplies the application device with voltage. Expediently, in this case, the second housing part may be arranged on the housing part in the region of the third portion of the wall of the first chamber.

For a further enhancement of the stimulation effect, the inner side of the wall of the sleeve-like body may preferably be provided at least locally with structural elements such as studs.

To control the stimulating action, it is furthermore preferably possible for a control device to be provided, which controls the application device and has at least one operating means in order to set at least one predetermined operating mode for the application device, wherein expediently the operating means has at least one switch or button.

Finally, the appliance may be configured preferably as a handheld unit, which is operated preferably with a battery for powering the application device.

In the following text, preferred exemplary embodiments of the invention are described in more detail with reference to the accompanying drawings, in which:

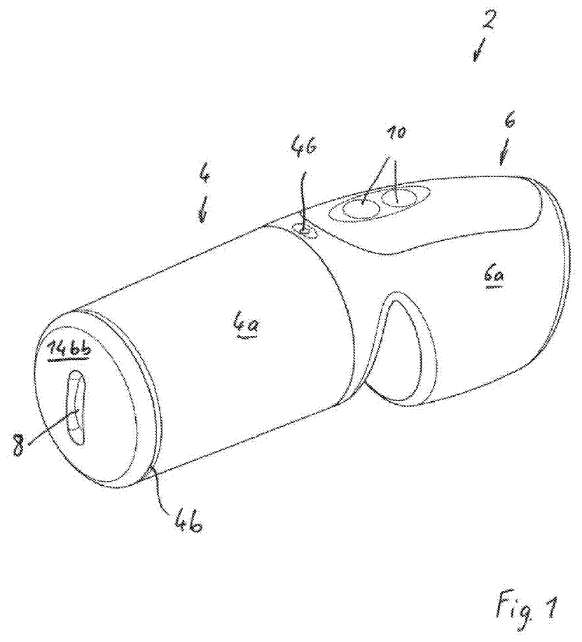

FIG. 1 shows a perspective view of a first preferred embodiment of the stimulation appliance;

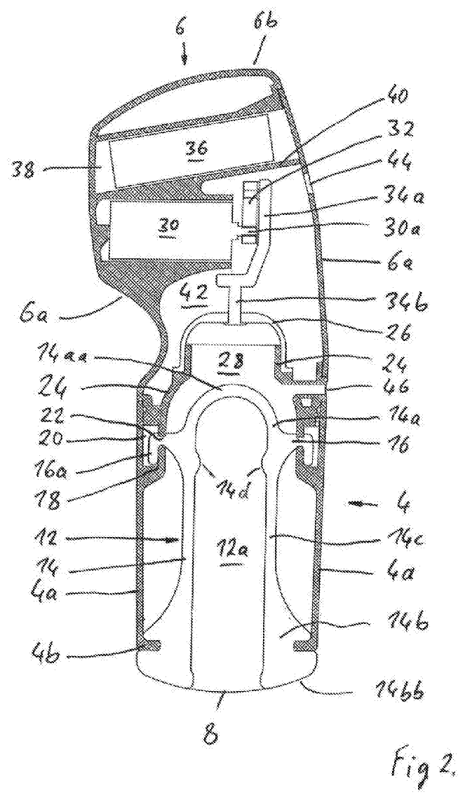

FIG. 2 shows a longitudinal section through the appliance in FIG. 1;

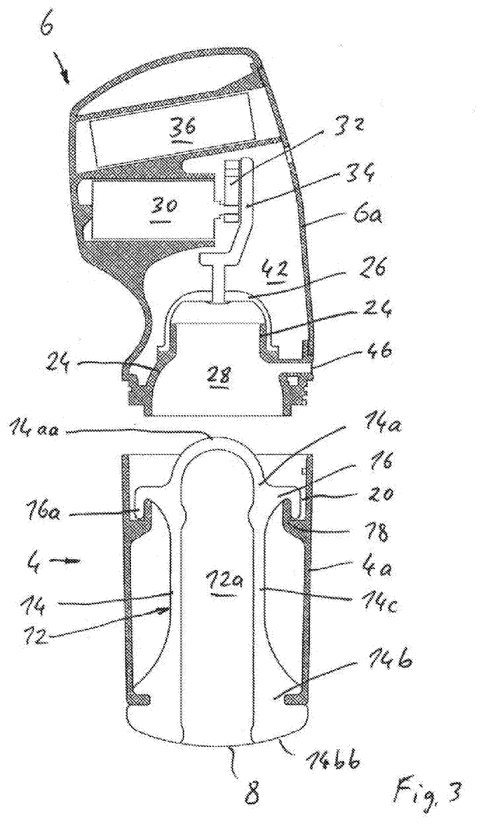

FIG. 3 shows the same longitudinal section as FIG. 2, but with the housing parts detached from one another;

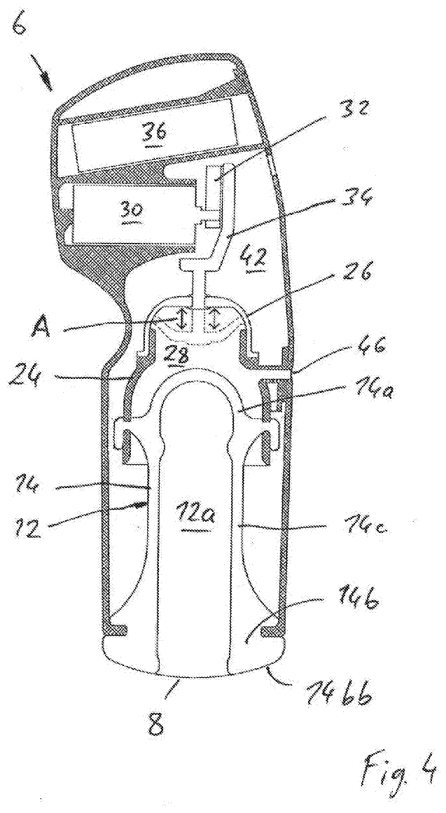

FIG. 4 shows the same longitudinal section as FIG. 2, but with the diaphragm additionally being illustrated by way of dashed lines in an intermediate position between a first end position (not illustrated) and a second end position, in which the diaphragm is depicted by way of solid lines;

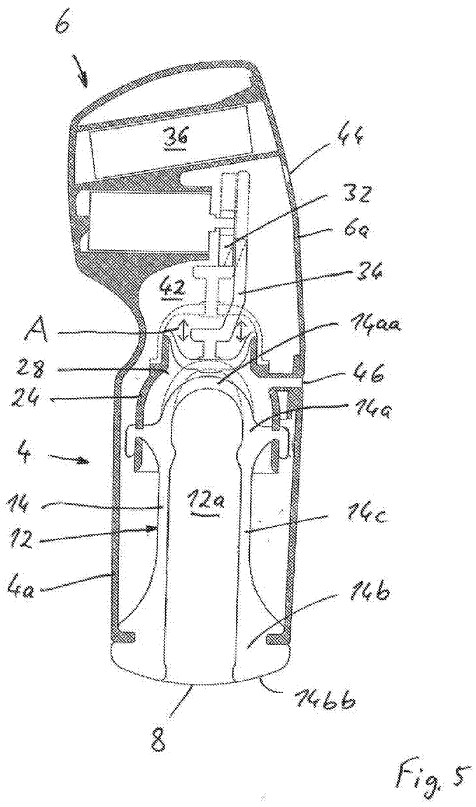

FIG. 5 shows the same longitudinal section as FIG. 2, but with the diaphragm being depicted in its first end position and the diaphragm additionally being illustrated by way of dashed lines in its second end position;

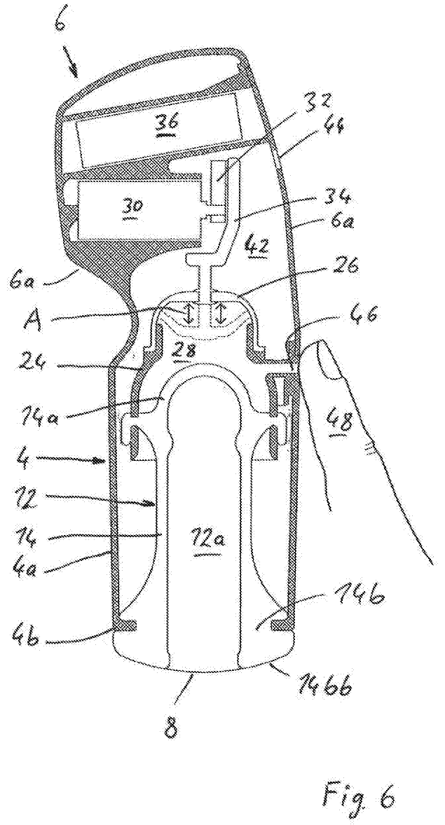

FIG. 6 shows the same longitudinal section as FIGS. 2 and 4 with the additional illustration of one of the user's fingers for closing an opening for manual control of the pressure conditions;

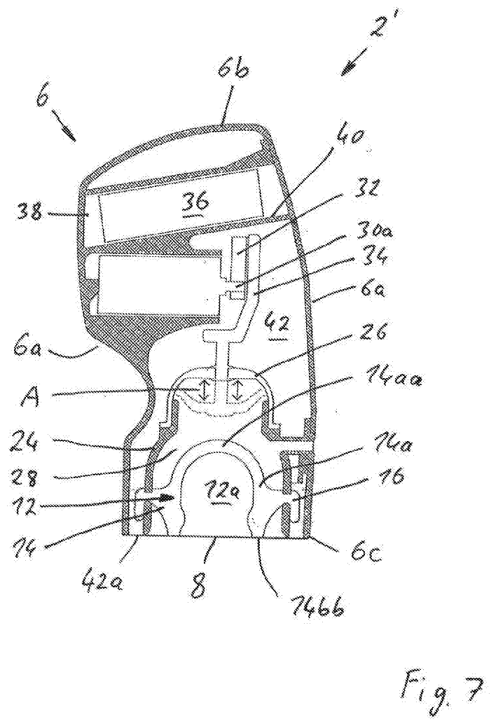

FIG. 7 shows a second preferred embodiment of the stimulation appliance in longitudinal section;

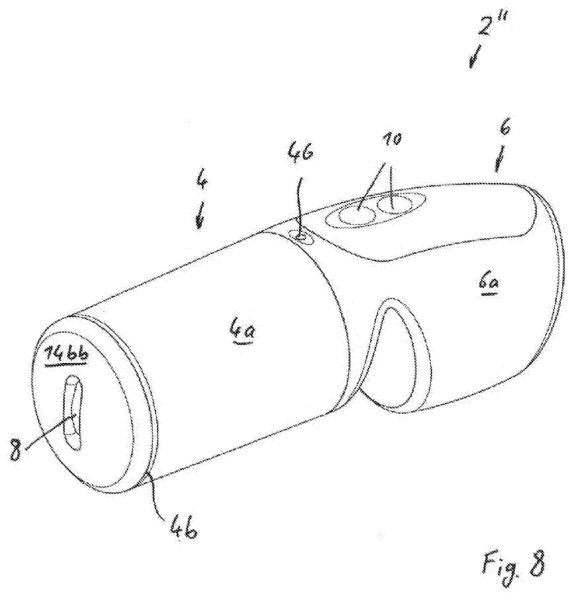

FIG. 8 shows a perspective view of a third preferred embodiment of the stimulation appliance;

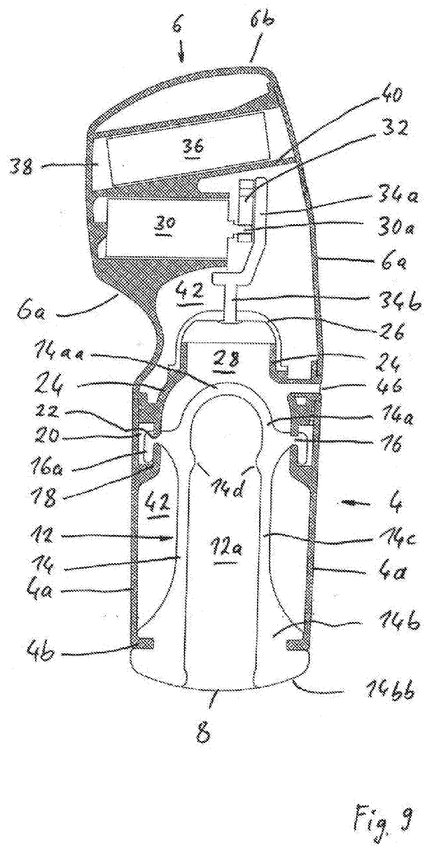

FIG. 9 shows a longitudinal section through the appliance in FIG. 8;

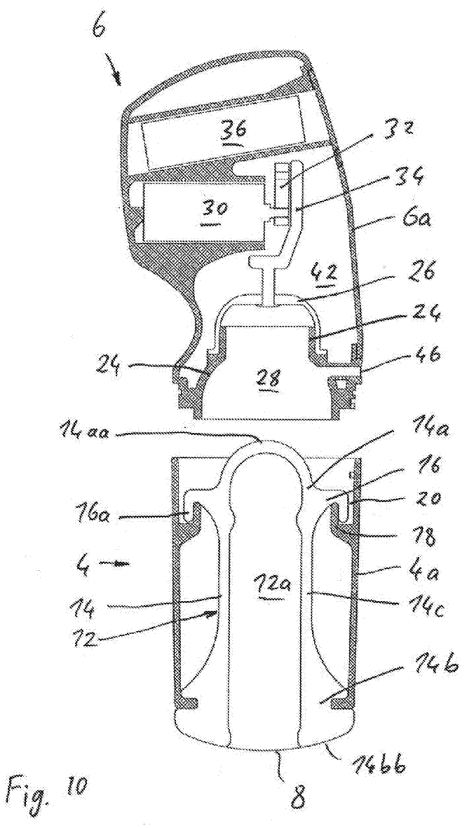

FIG. 10 shows the same longitudinal section as FIG. 9, but with the housing parts detached from one another;

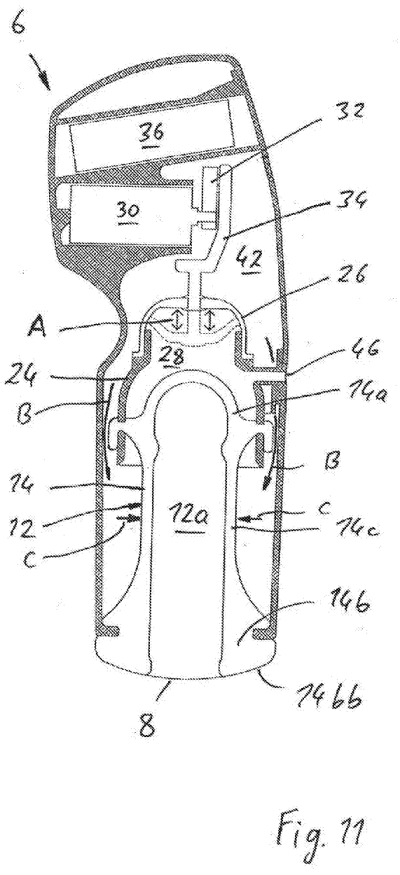

FIG. 11 shows the same longitudinal section as FIG. 9, but with the diaphragm additionally being illustrated by way of dashed lines in an intermediate position between a first end position (not illustrated) and a second end position, in which the diaphragm is depicted by way of solid lines;

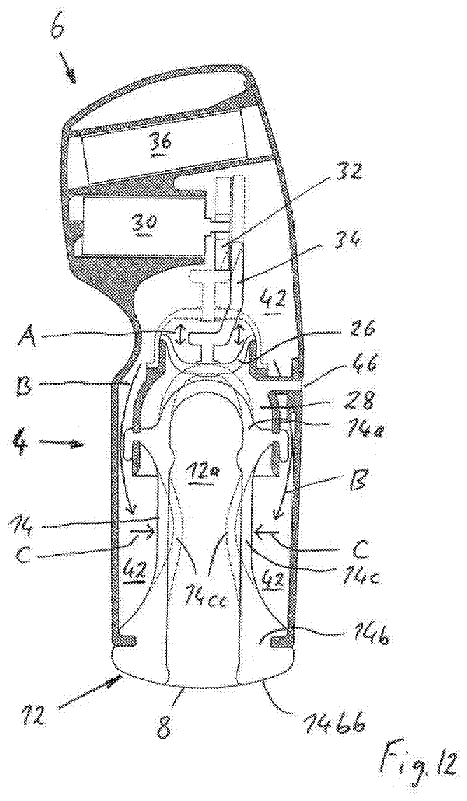

FIG. 12 shows the same longitudinal section as FIG. 9, but with the diaphragm being depicted in its first end position and the diaphragm additionally being illustrated by way of dashed lines in its second end position;

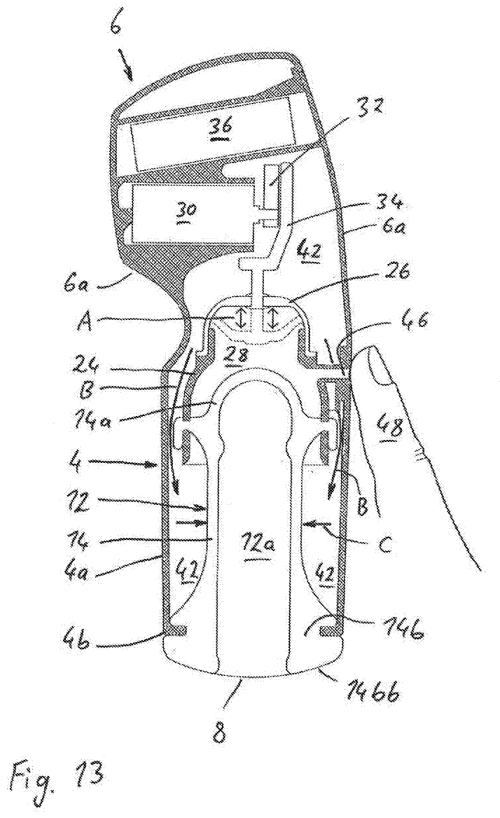

FIG. 13 shows the same longitudinal section as FIGS. 9 and 11 with the additional illustration of one of the user's fingers for closing an opening for manual control of the pressure conditions.

FIGS. 1 to 6 illustrate a stimulation appliance 2 according to a first preferred embodiment of the invention. The stimulation appliance 2 has a housing that is subdivided in the illustrated exemplary embodiment into a first housing part 4, which is bounded by a circumferential wall 4a and a free end 4b, and a second housing part 6, which is bounded by a circumferential wall 6a and a free end 6b. Located at the free end 4b of the first housing part 4 is an opening 8 for introducing a body part that is sensitive to stimulation, for example a penis. As is furthermore apparent from FIG. 1, control knobs 10 are arranged in the region of the circumferential wall 6a of the second housing part 6, said control knobs preferably being in the form of electric buttons and serving for switching the stimulation appliance on and off and for controlling it with the aid of an electronic control circuit that is not depicted in the figures.

As can be seen more specifically in FIGS. 2 to 6, in the illustrated exemplary embodiment, a sleeve-like body 12 is arranged in the interior of the first housing part 4, the interior or cavity 12a of said body 12 being bounded by a wall 14 that is subdivided into a first end portion 14a, a second end portion 14b, and a central portion 14c located between these two end portions 14a, 14b. The first end portion 14a of the wall 14 has the shape of a closed dome or of a closed cap in the illustrated exemplary embodiment and forms a first end 14aa, which at the same time also forms a first end of the sleeve-like body 12. The second end portion 14b, remote therefrom, of the wall 14 has a second end 14bb that at the same time also forms the external second end of the sleeve-like body 12 and is provided with the abovementioned opening 8 for introducing a body part that is sensitive to stimulation into the cavity 12a of the sleeve-like body 12. With regard to the free end 4b of the first housing part 4 and the opening 8, the first end portion 14a, or the first end 14aa of the wall 14 of the sleeve-like body 12, can alternatively also be referred to as the distal or internal first end portion 14a, or as the distal or internal first end 14aa, and the second end portion 14b, or the second end 14bb of the wall 14 of the sleeve-like body 12, can alternatively also be referred to as the proximal or partially external second end portion 14b, or as the proximal or external second end 14bb. As is furthermore apparent from FIGS. 2 to 6, between its two ends, the sleeve-like body 12 has an elongate shape, which, in the illustrated exemplary embodiment, is substantially cylindrical in particular in the region of the central portion 14c of the wall 14. In the illustrated exemplary embodiment, an inwardly projecting protrusion 14d, which forms a constriction, is furthermore arranged on the inner side of the wall 14 of the sleeve-like body 12 in the connecting region between the first end portion 14a and the central portion 14c, wherein this protrusion 14d can be optionally shaped in a circumferential manner or, in order to form studs, be provided with interruptions in the circumferential direction. The wall 14 of the sleeve-like body 12 consists of at least partially flexible, preferably elastic, material, which exhibits for example silicone, this being not only a particularly soft material but also a hygienic material.

As is furthermore apparent from FIGS. 2 to 6, in the illustrated exemplary embodiment, the free end 4b of the first housing part 4 forms an inwardly angled flange-like rim, which, in order to fix the adjacent portion of the sleeve-like body 12, engages in the second end portion 14b of the wall 14 of the sleeve-like body 12.

Likewise in the connecting region between its first end portion 14a and its central portion 14c, the wall 14 of the sleeve-like body 12 is provided on its outer side with an outwardly protruding collar 16, as is furthermore apparent from FIGS. 2 to 6. Adjacent to and opposite the collar 16, an inwardly projecting fastening protrusion 18 is formed on the inner side of the wall 4a of the first housing part 4, said fastening protrusion 18 containing a recess 20 that communicates with the interior of the first housing part 4 via an opening 22. As is apparent in particular from FIG. 2, the collar 16 provided on the outer side of the wall 14 of the sleeve-like body 12 projects through the opening 22 into the recess 20 and, in the illustrated exemplary embodiment, engages by way of a downwardly angled end 16a behind an inner-wall portion of the recess 20. Preferably, the collar 16 is configured as a collar that encircles the sleeve-like body 12 and accordingly the fastening protrusion 18 with the recess 20 is also formed in a circumferential manner on the inner wall of the first housing part 4; alternatively, however, it is also conceivable to subdivide the collar 16 into mutually spaced-apart, discrete parts and thus also to subdivide the fastening protrusion 18 or at least the recess 20 in a corresponding manner.

As is furthermore apparent from FIGS. 2 to 6, a circumferential wall portion 24 is provided outside the sleeve-like body 12 adjacently to and at a distance from the first end portion 14a of the wall 14 of the sleeve-like body 12, said wall portion 24 being arranged on the inner side of the wall 6a of the second housing part 6 and ending in the interior of the second housing part 6 with a circumferential free end, which is closed off in a sealed manner by a diaphragm 26, which is thus likewise arranged outside the sleeve-like body 12 and, in the illustrated exemplary embodiment, is spaced apart from the first end 14aa of the wall 14 of the sleeve-like body 12. Thus, the first end portion 14a of the wall 14 of the sleeve-like body 12, the wall portion 24 and the diaphragm 26 bound a first chamber 28.

As is apparent in particular from FIG. 2 in conjunction with FIG. 3, the recess 20 that receives the angled end 16a of the collar 16 integrally formed on the outer side of the wall 14 of the sleeve-like body 12 is bounded on its side facing the second housing part 6 by a portion of the wall portion 24. Since the wall portion 24 is provided on the second housing part 6, the result of this arrangement is that when the second housing part 6 is separated from the first housing part 4 (cf. FIG. 3), the recess 20 is opened, and so, in order to fit or remove the sleeve-like body 12, the collar 16 can simply be introduced by way of its angled end 16a into the now open recess 20 or removed from the cutout 20.

As is furthermore apparent from FIGS. 2 to 6, an electric motor 30 is arranged in the second housing part 6, a radially extending lever 32 being fastened to the output shaft 30a of said electric motor so as to rotate therewith. Adjacent to its free end, a connecting rod 34 is mounted in an articulated manner on the lever 32 with a first end 34a. With its other end 34b, the connecting rod 34 is fastened to the diaphragm 26. The lever 32 and the connecting rod 34 thus jointly form an eccentric drive, for converting the rotation of the output shaft 30a of the electric motor 30 into a reciprocating longitudinal movement of the connecting rod 34. Provided for powering the electric motor 30 is a (rechargeable) battery 36, which likewise sits within the second housing part 6 in a compartment 38 provided for this purpose, said compartment 38 being bounded by a partition wall 40.

Furthermore, with regard to the first chamber 28, a second chamber 42 is formed outside the wall portion 24 and the diaphragm 26 within the second housing part 6, said second chamber 42 being bounded by the wall 6a of the second housing part 6, the wall portion 24, the diaphragm 26 and the partition wall 40.

Since the diaphragm 26 consists of flexible material, in particular silicone, the reciprocating longitudinal movement of the connecting rod 34 in the direction of the double arrow A illustrated in FIGS. 4 to 6 results in a corresponding movement of the diaphragm 26, as is schematically illustrated in FIGS. 4 and 5; in other words, during its reciprocating movement in a longitudinal direction, the connecting rod 34 carries along the diaphragm 26 in a corresponding manner. Since the diaphragm 26 is fastened to the wall portion 24 with its outer end, the reciprocating movement of the connecting rod 34 causes the shape of the diaphragm 26 to change, and in this case the stroke movement of the diaphragm 26 is greatest in its center, where the connecting rod 34 is fastened with its adjacent end 34b, and corresponds to the stroke movement of the connecting rod 34. The reciprocating longitudinal movement of the connecting rod 34 is oriented more or less in the longitudinal direction of the sleeve-like body 12, such that the movement of the connecting rod 34 subjects the diaphragm 26 to a change in distance from the adjacent first end 14aa of the wall 14 of the sleeve-like body 12 in that, put another way, it is moved alternately in the direction of the first end 14aa of the wall 14 of the sleeve-like body 12 and away therefrom.

In FIG. 5, the diaphragm 26 is depicted in its first end position closest to the sleeve-like body 12 by way of solid lines. It is apparent from FIG. 5 that, in the (lower, according to FIG. 5) first end position, the diaphragm 26 adopts an arcuate shape in the direction of the sleeve-like body 12. When the diaphragm 26 is in its first end position, the opposite first end portion 14a of the wall 14 of the sleeve-like body 12 likewise adopts a defined first end position at the same time, in which the distance between the first end 14aa of the wall 14 of the sleeve-like body 12 from the diaphragm 26 is at a minimum. In FIG. 5, the first end portion 14a of the wall 14 of the sleeve-like body 12 is also depicted in its (lower, according to FIG. 5), first end position by way of solid lines. Furthermore, in FIG. 5, the diaphragm 26 is depicted in its (upper, according to FIG. 5) second end position away from the sleeve-like body 12 by way of dashed lines, in which position the diaphragm 26 now adopts an upwardly arcuate shape, curved in the opposite direction to the first end position. When the diaphragm 26 is in its second end position, the first end portion 14a of the wall 14 of the sleeve-like body 12 likewise adopts a matching (upper, according to FIG. 5) defined second end position, which is likewise depicted by way of dashed lines in FIG. 5. Thus, it is apparent from FIG. 5 that the sleeve-like body 12 is stretched in its longitudinal direction and accordingly lengthened in the second end position of the first end portion 14a of its wall 14 compared with the first end position thereof. Only for the sake of clarity, it should also be noted in this connection that in FIGS. 2 to 4 and 6, the diaphragm 26 is in its second end position in each case, but, by contrast, the first end portion 14a of the wall 14 of the sleeve-like body 12 is depicted in its first end position; in this case, FIGS. 4 and 6 additionally show the diaphragm 26 in an intermediate position, illustrated by way of dashed lines, between the two above-discussed end positions.

The movement of the diaphragm 26 from its (lower, according to FIG. 5) first end position into its (upper, according to FIG. 5) second end positions causes the first end portion 14a of the wall 14 of the sleeve-like body 12 to move from its (lower, according to FIG. 5) first end position into its (upper, according to FIG. 5) second end position, such that the movement of the diaphragm 26 on account of the reciprocating movement of the connecting rod 34 has a direct effect on the movement of the first end portion 14a of the wall 14 of the sleeve-like body 12. This is caused by the first chamber 28, which is formed between the first end portion 14a of the wall 14 of the sleeve-like body 12 on one side and the diaphragm 26 on the other and is filled with air. The air in the first chamber is responsible for the fact that when the diaphragm 26 moves, the first end portion 14a of the wall 14 of the sleeve-like body 12 is carried along in a corresponding manner. When the diaphragm 26 moves from its (lower, according to FIG. 5) first end position into the (upper, according to FIG. 5) second end position, first of all the volume in the first chamber 28 is increased and a negative pressure initially arises therein as a result, this causing the first end portion 14a of the wall 14 of the sleeve-like body 12 to be subjected to a corresponding tensile force. This tensile force then ensures that the first end portion 14a of the wall 14 of the sleeve-like body 12 moves into the (upper, according to FIG. 5) second end position, which is indicated by dashed lines in FIG. 5, until the negative pressure has been broken down in the first chamber 28 and a normal air pressure prevails again. Thus, while the diaphragm 26 moves from the first end position into the second end position, it correspondingly carries along the first end portion 14a of the wall 14 of the sleeve-like body 12 under a suction effect via the air cushion prevailing in the first chamber 28, causing the sleeve-like body 12 to stretch in the direction of its longitudinal extension and thus to increase in length. When the diaphragm 26 moves in the opposite direction from its (upper, according to FIG. 5) second end position into its (lower, according to FIG. 5) first end position, a positive pressure initially arises in the first chamber 28, this exerting a compressive force on the first end 14aa of the wall 14 of the sleeve-like body 12, which is still stretched at this time, said compressive force ensuring that the first end portion 14a of the wall 14 of the sleeve-like body 12 returns into its (lower, according to FIG. 5) first end position, which is illustrated by solid lines in FIG. 5.

The alternate change in length, brought about by the reciprocating movement of the connecting rod 34, of the first end portion 14a of the wall 14 of the sleeve-like body 12 creates a particular stimulating action on the portion of a body part (not depicted in the figures) sensitive to stimulation that has been introduced through the opening 8 in the sleeve-like body 12 and is engaged with the first end portion 14a of the wall 14 of the sleeve-like body 12, in that either, on account of a relative movement of the first end portion 14a of the wall 14 of the sleeve-like body 12 with respect to the adjacent portion of said body part, a stimulating rubbing action is created on the latter, or the first end portion 14a of the wall 14 of the sleeve-like body 12, while moving alternately in the two directions, carries along the adjacent portion of said body part or at least the skin thereof, this likewise resulting in a particular stimulation effect.

In order that an undesired air cushion does not form in the second chamber 42, which would form a kind of opposition to the movement of the diaphragm 26 and would thus impair or even completely prevent the movement of the diaphragm 26, a vent hole 44 is provided in the wall 6a of the second housing part 6, said vent hole 44 ensuring continuous pressure equalization between the second chamber 42 and the environment. This ensures undisrupted movement of the diaphragm 26.

As can be seen in particular in FIG. 6, an opening 46 is provided, by way of which the first chamber 28 can communicate with the outside. This opening 46 can expediently be partially or completely closed by a finger 48 of a user (not illustrated in the figures) if required, in order in this way to manually control the pressure in the first chamber 28. If the opening 46 is completely closed, the pressure conditions in the first chamber 28 remain unchanged. By contrast, if the opening 46 is partially closed or open, this brings about slight pressure equalization with the environment, with the result that the pressure in the first chamber 28 is accordingly lower. In this case, the opening 46 should contain a nonreturn valve (not illustrated in the figures), which closes when there is a negative pressure in the first chamber 28 and opens when there is a positive pressure in the first chamber 28, such that, in the event of a negative pressure in the first chamber 28, undesired pressure equalization with the environment is avoided and manual control of the pressure conditions in the first chamber 28 is possible by the opening 46 being partially or completely closed by a user's finger 48 only in the event of a positive pressure in the first chamber 28.

FIG. 7 illustrates a stimulation appliance 2′ according to a second preferred embodiment, wherein, with regard to the stimulation appliance 2 according to the first preferred embodiment, identical components are indicated by the same reference signs and so, in this regard, to avoid repetitions, reference is made to the description given above with reference to FIGS. 1 to 6.

The stimulation appliance 2′ according to the second preferred embodiment makes use of the same operating principle as the stimulation appliance 2 according to the first preferred embodiment. The difference compared with the stimulation appliance 2 according to the first preferred embodiment is that, in the stimulation appliance 2′ according to the first preferred embodiment, the first housing part 4 is missing and the second housing part 6 is provided as a single housing and as a result, in addition to the (upper, according to FIG. 7) free end 6b, has a further (lower, according to FIG. 7) free end 6c, which is remote from this free end 6b and to which the collar 16 of the wall 14 of the sleeve-like body 12 is fastened. Since the second chamber 42 is open toward the environment at the (lower, according to FIG. 7) free end 6c of the housing part 6 at a point identified by the reference sign “42a” in FIG. 7, it is furthermore possible for the vent hole 44 provided in the stimulation appliance 2 according to the first preferred embodiment to be dispensed with. The use of the second housing part 6 of the stimulation appliance 2 according to the first preferred embodiment as a single housing also has the result that the sleeve-like body 12 has a much shorter length and is thus considerably shortened, as can also be seen in FIG. 7 compared with FIGS. 1 to 6. Thus, the second end portion 14b of the wall 14 of the sleeve-like body 12 immediately adjoins the collar 16 and is formed in a much shorter manner than the stimulation appliance 2 according to the first preferred embodiment. Accordingly, the stimulation appliance 2′ according to the preferred second embodiment is a structurally simplified version that is more compact in terms of its design compared with the stimulation appliance 2 according to the first preferred embodiment.

FIGS. 8 to 13 depict a stimulation appliance 2″ according to a third preferred embodiment, wherein FIGS. 8 to 13 correspond to FIGS. 1 to 6 in terms of view and, with regard to the stimulation appliance 2 according to the first preferred embodiment, identical components are indicated by the same reference signs and so, in this regard, to avoid repetitions, reference is made to the description of the stimulation appliance 2 according to the first preferred embodiment that is given above with reference to FIGS. 1 to 6.

At first sight, the stimulation appliance 2″ according to the third preferred embodiment appears to be the same as the stimulation appliance 2 according to the first preferred embodiment. However, there is a significant difference in operating principle, which is also reflected in structural differences.

Although an oscillating change in length of the sleeve-like body 12 on account of the reciprocating movement, oriented in the longitudinal direction of the sleeve-like body 12, of the diaphragm 26 also takes place in the stimulation appliance 2″ according to the third preferred embodiment, reference also being made, in this regard, to the description of the stimulation appliance 2 according to the first preferred embodiment that is given above with reference to FIGS. 1 to 6, in contrast to the stimulation appliance 2 according to the first preferred embodiment, the second chamber 42 is closed with respect to the environment and therefore the vent hole 44 is also missing, such that, on account of the reciprocating movement of the diaphragm 26, oscillating pressure conditions are also established therein, but in an opposite or reverse manner to the oscillating pressure conditions that arise in the first chamber 28. When the diaphragm 26 moves from its (lower, according to FIG. 12) first end position, illustrated by solid lines in FIG. 12, into its (upper, according to FIGS. 9 to 13) second end position, illustrated by solid lines in FIGS. 9 to 11 and 13 and by dashed lines in FIG. 12, a positive pressure initially arises in the second chamber 42, this positive pressure then being applied to the central portion 14c of the wall 14 of the sleeve-like body 12 from the outside, resulting in shortening of the distance between mutually opposite wall portions 14cc of the central portion 14c of the wall 14 of the sleeve-like body 12, as can be seen in FIG. 12, in which those wall portions 14cc are depicted schematically by way of dashed lines. The second chamber 42 is formed not only by the space between the diaphragm 26 and the partition wall 40, but also by a space that is bounded by the wall 4a of the first housing part 4 on one side and by the wall portion 24 and the central portion 14c and the second end portion 14b of the wall 14 of the sleeve-like body 12 on the other side. Thus, the second chamber 42 additionally extends along the outer side of the sleeve-like body 12 as far as the second end portion 14b of the wall 14 thereof, said second end portion 14b being fastened in a sealed manner to the wall 4a of the first housing part 4 in the region of the free end 4b thereof. The positive pressure in the second chamber 42 that is initially brought about by the movement of the diaphragm 26 from its first end position into its second end position has the result that the air located in the second chamber 42 is displaced in the direction of the arrows B shown in FIGS. 11 to 13 and then hits the outer side of the central portion 14c of the wall 14 of the sleeve-like body 12. There, the air then creates a compressive force, which acts transversely from the outside on the central portion 14c of the wall 14 of the sleeve-like body 12 in the direction of the arrows C shown in FIGS. 11 to 13. This compressive force brings about the above-discussed reduction in distance between the mutually opposite wall portions 14cc in the region of the central portion 14c of the wall 14 of the sleeve-like body 12 and thus, in this region, a constriction of the cavity 12a of the sleeve-like body 12, as is illustrated schematically in FIG. 12 by way of dashed lines. Accordingly, the movement of the diaphragm 26 from its (lower, according to FIG. 12) first end position into its (upper, according to FIG. 12) second end position results not only in stretching but at the same time also in constriction of the sleeve-like body 12.

When the diaphragm 26 moves in the opposite direction from its (upper, according to FIG. 12) second end position into its (lower, according to FIG. 12) end position, a negative pressure initially arises in the second chamber 42, this ensuring an opposite air flow counter to the orientation of the arrows B and C illustrated in FIGS. 11 to 13 and thus away from the central portion 14c of the wall 14 of the sleeve-like body 12. As a result, a tensile force is applied to the mutually opposite wall portions 14cc of the central portion 14c of the wall 14 of the sleeve-like body 12, this tensile force ensuring that, with an increase in their distance from one another, these wall portions 14cc return into their substantially straight starting position, illustrated by way of solid lines in FIGS. 9 to 13, and the constriction of the cavity 12a of the sleeve-like body 12 is undone. Thus, in this step, in addition to the reduction in its length, the central portion 14c of the wall 14 of the sleeve-like body 12 at the same time also returns into its original, substantially straight starting position with an increase in the distance between its wall portions 14cc and resultant elimination of the constriction.

Accordingly, with the stimulation appliance 2″ according to the third preferred embodiment illustrated in FIGS. 9 to 13, the stimulation effect can be enhanced even further in that not only the first end portion 14a of the wall 14 of the sleeve-like body 12 and thus the first end thereof is subjected alternately to a tensile force and a compressive force in the longitudinal direction of the sleeve-like body 12, in order to change the length of the sleeve-like body 12 and thus periodically stretch the latter, but also the sleeve-like body 12 is subjected alternately to a tensile force and compressive force acting transversely to its longitudinal direction in the region of the central portion 14c of its wall 14, in order to change the cross section of the sleeve-like body 12 and thus periodically create a constriction. In light of the foregoing, in the stimulation appliance 2″ according to the third preferred embodiment, the positive and negative pressure generated in the second chamber 42 by the diaphragm 26 outside the first chamber 28 is used cleverly for a further stimulation effect by periodic constriction of the sleeve-like body 12.

1. A stimulation appliance comprising:
a sleeve-like body formed by an at least partially flexible wall that has a first end portion with a first end forming a first end of the sleeve-like body, and a second end portion, remote from the first end portion, with a second end forming a second end of the sleeve-like body, said second end being located substantially opposite the first end, being arranged at a distance from the first end, and containing an opening for introducing a body part that is sensitive to stimulation into the sleeve-like body,
characterized by,
an application device, which is configured to apply a temporally variable, in particular oscillating first force that varies the distance between the first end of the sleeve-like body and the second end of the sleeve-like body to the first end portion of the wall of the sleeve-like body, alternately as a tensile force for a relative increase in the distance between the first end and the second end of the sleeve-like body and as a compressive force for a relative decrease in the distance between the first end and the second end of the sleeve-like body.

2-38. (canceled)
